(19) United States
(12) Patent Application Publication
(10) Pub. No.: US 2006/0107525 A1
(43) Pub. Date: May 25, 2006

(54) Method and system for creating alignment holes in a multilayer structure

(76) Inventor: William Riis Hamburgen, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/996,033

(22) Filed: Nov. 22, 2004

(51) Int. Cl. H01R 43/00

(52) U.S. Cl. 29/885

(57) ABSTRACT

An aspect of the present invention is a method of creating alignment holes in a multilayer structure that includes depositing a metal layer in contact with a polymer layer of material, patterning the metal layer and creating alignment holes in the multilayer structure based on the patterned metal layer.

### FIELD OF THE INVENTION

The present invention relates generally to multilayer fabrication methodologies and particularly to a method for creating alignment holes in a multilayer structure.

### BACKGROUND OF THE INVENTION

The construction of multilayer circuit boards and the processes used to produce them are well understood. Through vias or alignment holes that interconnect one side of a circuit board completely to the other and that have been made conductive have been the Z-Axis interconnect technology choice for multilayer circuit boards for years. These alignment holes are typically mechanically drilled in stacks on numerically controlled multi-spindle drill machine.

Surface mount technology where the component leads make interconnections on the surface instead of in the holes actually increases the demand for vias for electrical interconnections to internal layers in multilayer circuits. As surface mount components increase in pin or lead counts, the pin density become closer. The dense component placement and dense pin count on multilayer circuit boards and polymer based multichip modules creates an interconnect density problem in the Z-Axis.

In traditional multilayer circuit board construction, alignment holes are punched into the layers after the metal has been patterned. This inevitably results in a mis-registration between the metal pattern and the alignment hole.

Accordingly, what is needed is a more precise approach to the formation of alignment holes in multi-layer structure. The approach should be simple, inexpensive and capable of being easily adapted to existing technology. The present invention addresses these needs.

### SUMMARY OF THE INVENTION

An aspect of the present invention is a method of creating alignment holes in a multilayer structure that includes depositing a metal layer in contact with a polymer layer of material, patterning the metal layer and creating alignment holes in the multilayer structure based on the patterned metal layer.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a flow chart of a method of creating alignment holes in a multilayer structure in accordance with an embodiment of present invention.

FIG. 2 shows a multilayer structure in accordance with an embodiment of the present invention.

FIGS. 2(a)-2(d) show multiple structures in accordance with varying embodiments of the present invention.

FIG. 3 shows an exemplary CO₂ laser system.

### DETAILED DESCRIPTION

The present invention relates to a method of creating alignment holes in a multilayer structure. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

In accordance with varying embodiments, an innovative method of creating alignment holes for use in assembling multilayer structures is disclosed. Accordingly, a patterned metal layer is utilized as an aperture mask in conjunction with a laser etch step to create alignment holes in a multilayer structure. By utilizing the patterned metal layer as an aperture mask in conjunction with a laser etch step, misregistration between the metal pattern and the alignment holes is avoided.

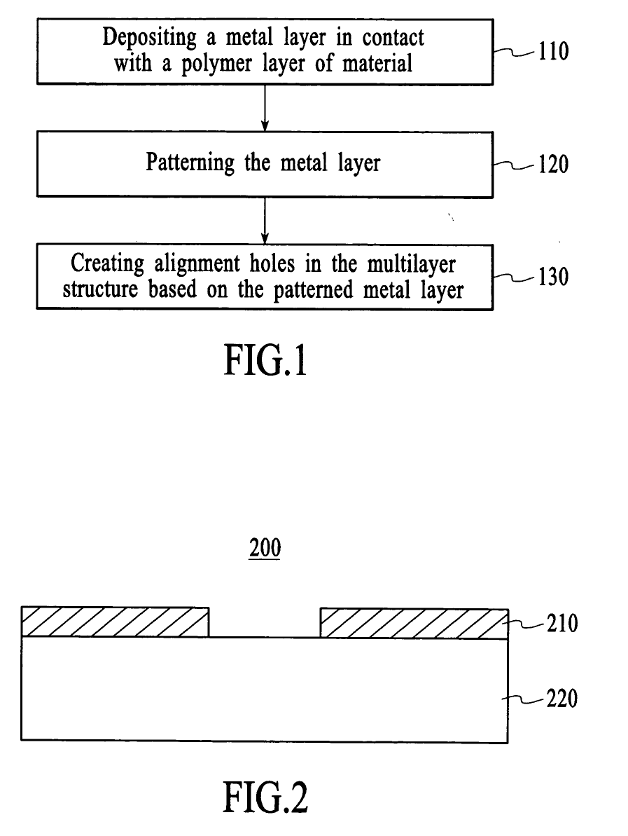

FIG. 1 is a flow chart of a method of creating alignment holes in a multilayer structure. A first step 110 includes depositing a metal layer in contact with a polymer layer of material. In embodiment, the metal layer is a copper material or the like. The next step 120 includes patterning the metal layer. The final step 130 involves creating alignment holes in the multilayer structure based on the patterned metal layer.

In an embodiment, step 110 is accomplished using one of a variety of different deposition techniques. These include, but are not limited to sputtering processes, Plasma Enhanced Chemical Vapor Deposition (PECVD) and the like. For example, sputtering is done by bombarding a target material with a charged gas (typically argon) which releases atoms in the target that coats the nearby substrate. The process typically takes place inside a magnetron vacuum chamber under low pressure.

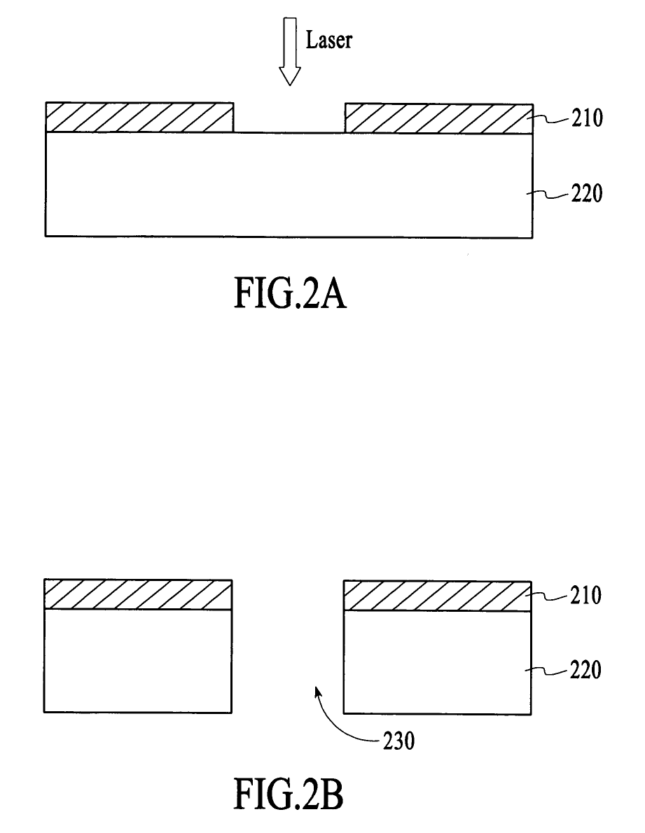

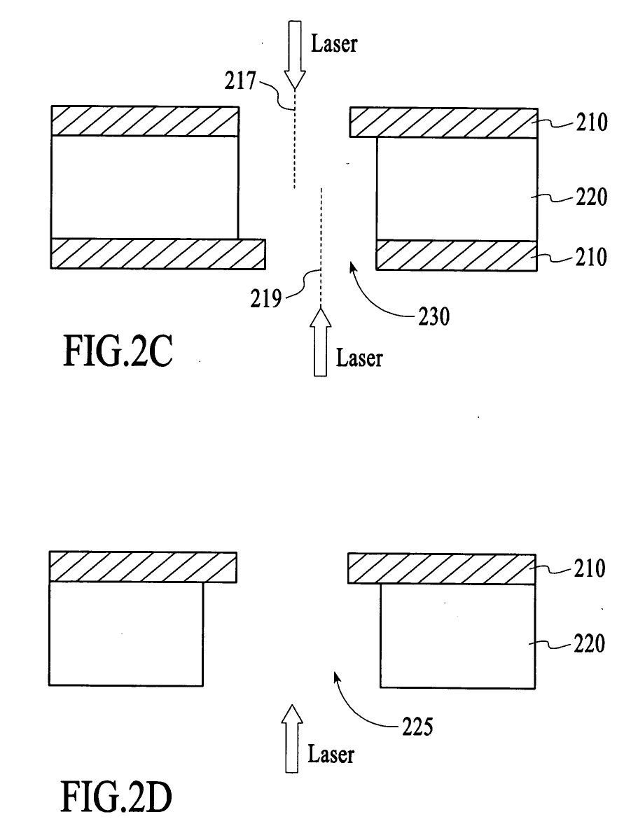

In an embodiment, step 120 is accomplished with a dry film (sheet) photomask, exposure and a subtractive etch. Liquid photomasks are possible, as are “build-up” processes that start with a thin sputterd copper layer, a masking step and an exposure step. Conductors are then electroplated up, the mask stripped, and all the copper etched until the thin sputtered layer is gone and the traces are isolated. FIG. 2 shows a multilayer structure 200. The structure includes a patterned metal layer 210 in contact with a polymer layer 220.

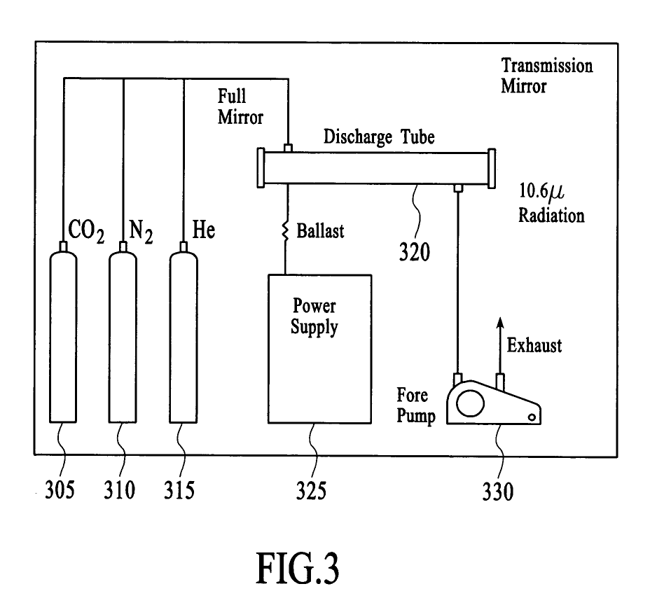

In an embodiment, step 130 is accomplished by employing a laser with a high etch selectivity for the underlying polymer layer vs. the patterned metal layer. For example, a CO₂ laser could be employed. An exemplary CO₂ laser system 300 is shown in FIG. 3. The system 300 includes a CO₂ tank 305, a N₂ tank 310 and a He tank 315. The three tanks 305, 310, 315 are couple to a discharge tube 320 wherein the discharge tube 320 includes a full mirror 317 and a transmission mirror 327. The discharge tube 320 is coupled to a pump 330 and a power supply 325 via a ballast resistor 323.

During operation, three gases (CO₂, N₂ and He) are mixed and fed into one end of the discharge tube 320 at a pressure of a few torr. The gas flows down the end of the tube 320 in about one second and is pumped out the far end with the mechanical pump 330. An electrical discharge is maintained between the metallic end flanges of the tube 320. The ballast resistor 323 is employed because of the negative dynamic resistance of the discharge. With the fully reflecting mirror 317 on the left and a partially transmitting mirror 327 on the right, the device becomes a laser which radiates in the far infrared at 10.6 microns.

Although the above-described embodiment discloses the employment of a CO₂ laser, one of ordinary skill in the art will readily recognize that a different means of performing a highly directional selective etch could be used while remaining within the spirit and scope of the present invention.

Referring back to FIG. 2, the mis-registration that can occur between the metal pattern 210 and the alignment hole is eliminated by using the lasering system to remove the polymer within the alignment hole.

FIGS. 2(a) and 2(b) show a first embodiment of the process. According to the first embodiment, lasering is done from the “metal side” i.e. the side on which the metal pattern 210 resides. Consequently, since the laser has a high etch selectivity for the underlying polymer layer 220 vs. the patterned metal layer 210, the patterned metal layer 210 serves as an aperture mask and the uncovered polymer material is removed resulting in the creation of an alignment hole 230.

It should be noted that although the first embodiment is perhaps best suited to layers with a metal pattern on only one side, a second embodiment involves creating an alignment hole in a double-sided layer by lasering from both sides. FIG. 2(c) shows the second embodiment of the process. In this embodiment, lasering is done from both sides. In this case the alignment hole 230 size in the polymer material 220 will be the union of the areas of the two metal holes. This will tend to center the alignment pin at a position that represents the average of each of the metal pattern centerlines 217, 219.

FIG. 2(d) shows a third embodiment of the process. According to the third embodiment, lasering is done from the “polymer side” i.e. the side on which the polymer 220 resides. In this embodiment, an oversized hole 225 is trepanned in the polymer material 220 and the back of the patterned metal layer 210 is used as a laser stop. Under this approach, it is desirable that the lasered-to-metal-hole alignment tolerance is smaller than the metal thickness, otherwise there will be excessive metal overhang and the edge of the alignment hole will be fragile.

It should be noted that in any of the above-described embodiments, it is desirable to have the alignment pin enter the alignment hole from the metal side, to minimize the chance that pin-to-hole friction will cause the metal to peel back from the substrate at the edge of the hole.

In accordance with varying embodiments, an innovative method of creating alignment holes in a multilayer structure is disclosed. Accordingly, a patterned metal layer is utilized as an aperture mask in conjunction with a laser etch step to create alignment holes in a multilayer structure. By utilizing the patterned metal layer as an aperture mask in conjunction with a laser etch step, misregistration between the metal pattern and the alignment holes is avoided.

Without further analysis, the foregoing so fully reveals the gist of the present invention that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

What is claimed:

1. A method of creating alignment holes in a multilayer structure comprising:
depositing a metal layer in contact with a polymer layer of material;
patterning the metal layer; and
creating alignment holes in the multilayer structure based on the patterned metal layer.

2. The method of claim 1 wherein the metal layer comprises a copper material.

3. The method of claim 1 wherein creating alignment holes in the multilayer structure based on the patterned metal layer further comprises:
lasering the multilayer structure wherein the patterned metal layer is used as an aperture mask.

4. The method of claim 3 wherein lasering the multilayer structure further comprises:
utilizing a laser with a high etch selectivity for the polymer layer with respect to the metal layer.

5. The method of claim 3 wherein the multilayer structure includes a metal side and a polymer side and lasering the multilayer structure further comprises:
lasering the multilayer structure from the metal side.

6. The method of claim 3 wherein the multilayer structure includes a metal side and a polymer side and lasering the multilayer structure further comprises:
lasering the multilayer structure from the polymer side.

7. The method of claim 3 wherein the multilayer structure includes a metal side and a polymer side and lasering the multilayer structure further comprises:
lasering the multilayer structure from the metal side and the polymer side.

8. The method of claim 4 wherein the laser comprises a CO₂ laser.

9. A system for creating alignment holes in a multilayer structure comprising:
means for depositing a polymer layer;
means for depositing a metal layer in contact with the polymer layer;
means for forming a pattern in the metal layer; and
means for creating alignment holes in the multilayer structure based on the pattern.

10. The system of claim 9 wherein the metal layer comprises a copper material.

11. The system of claim 9 wherein the means for creating alignment holes in the multilayer structure based on the patterned metal layer further comprises:
means for lasering the multilayer structure wherein the patterned metal layer is used as an aperture mask.

12. The system of claim 11 wherein the means for lasering the multilayer structure further comprises:
a laser with a high etch selectivity for the polymer layer with respect to the metal layer.

13. The system of claim 11 wherein the multilayer structure includes a metal side and a polymer side and the means for lasering the multilayer structure further comprises:
means for lasering the multilayer structure from the metal side.

14. The system of claim 11 wherein the multilayer includes a metal side and a polymer side and the means for lasering the multilayer structure further comprises:
means for lasering the multilayer structure from the polymer side.

15. The system of claim 11 wherein the multilayer includes a metal side and a polymer side and the means for lasering the multilayer structure further comprises:
means for lasering the multilayer structure from the metal side and the polymer side.

16. The system of claim 12 wherein the laser comprises a CO₂ laser.
